(19) United States
(12) Patent Application Publication
(10) Pub. No.: US 2025/0139345 A1
(43) Pub. Date: May 1, 2025

(54) MACHINE LEARNING-BASED SEMICONDUCTOR PROCESS OPTIMIZATION METHOD AND SYSTEM

(71) Applicants: RESEARCH COOPERATION FOUNDATION OF YEUNGNAM UNIVERSITY, Gyeongsan-si (KR); POSTECH RESEARCH AND BUSINESS DEVELOPMENT FOUNDATION, Pohang-si (KR)

(72) Inventors: Hyun Chul CHOI, Daegu (KR); Chang Hyeon AN, Gyeongsan-si (KR); Rock Hyun BAEK, Pohang-si (KR); Hyeok YUN, Pohang-si (KR)

(73) Assignees: RESEARCH COOPERATION FOUNDATION OF YEUNGNAM UNIVERSITY, Gyeongsan-si (KR); POSTECH RESEARCH AND BUSINESS DEVELOPMENT FOUNDATION, Pohang-si (KR)

(21) Appl. No.: 18/814,380

(22) Filed: Aug. 23, 2024

(30) Foreign Application Priority Data
Oct. 26, 2023 (KR) 10-2023-0144301

(51) Int. Cl. G06F 30/337; G06F 119/06; G06F 119/18

(52) U.S. Cl. CPC G06F 30/337; G06F 2119/06; G06F 2119/18

(57) ABSTRACT

A machine-learning method for semiconductor process optimization may include inputting semiconductor-related parameters into each of first neural network models and outputting, based on the semiconductor-related parameters, a predicted figure of merit of a semiconductor device as a first output value from each of the first neural network models. After a semiconductor manufacturing process is performed with a semiconductor manufacturing parameter, electrical measurement parameter values may be measured using one or more measuring devices. The semiconductor-related parameters may include electrical measurement parameter values measured on one or more semiconductor devices. The method may also utilize a feedback loop between an output and an input of the first neural network models so that the electrical measurement parameter values can be updated based on an output value of the first neural network models. A second neural network model may also be used. A computing device and a system are also disclosed.

### CROSS-REFERENCE TO RELATED APPLICATION(S)

This application claims the benefit of and priority to Korean Patent Application No. 10-2023-0144301, filed on Oct. 26, 2023, the entirety of which is incorporated herein by reference for all purposes.

### BACKGROUND

### Field

Embodiments of the present disclosure relate to machine-learning techniques and semiconductor process, and particularly to, for example, without limitation, a machine learning-based semiconductor process optimization method and system.

### Description of Related Art

In recent years, neural networks have been actively used to predict and analyze the impact of semiconductor design and manufacturing processes and optimize device characteristics. However, in semiconductor processes demanding significant investment and precise yield control, utilizing neural networks for optimization and process monitoring with uncertain reliability can potentially yield detrimental results. Therefore, it is vital to verify results obtained using a neural network.

In particular, since electrical properties of manufactured devices have a non-uniform distribution, including uncontrollable variability, data density is not constant over the entire range. Consequently, there exists a sparse data space where the accuracy of neural network predictions may deteriorate. Moreover, when training and validation data sets are split to prevent overfitting of the neural network in the sparse data space, the prediction error in the sparse data space is further expanded due to the lack of training data.

Furthermore, when gradient descent is applied to a single neural network to optimize the input for low output in the sparse data space, the optimal input has an output deviation according to the training index of the neural network. That is, the input optimized with a single neural network can result in significant output variations, posing a challenge to the reliability of optimization processes.

The description of the related art should not be assumed to be prior art merely because it is mentioned in or associated with this section. The description of the related art includes information that describes one or more aspects of the subject technology, and the description in this section does not limit the invention.

### SUMMARY

The inventors of the present disclosure have recognized the problems and disadvantages of the related art and have performed extensive research. The inventors of the present disclosure have thus invented a new method and a new system that substantially obviate one or more problems due to limitations and disadvantages of the related art.

The disclosed embodiments are intended to provide a machine-learning method for semiconductor process optimization, capable of decreasing output variation and increasing reliability, and a computing device for performing the same.

In one or more aspects, there is provided a machine-learning method for semiconductor process optimization that is executed in a computing device including one or more processors and a memory storing one or more programs executed by the one or more processors. The machine-learning method may include inputting semiconductor-related parameters into each of a plurality of first neural network models and outputting, based on the semiconductor-related parameters, a predicted figure of merit of a semiconductor device as a first output value from each of the plurality of first neural network models. The semiconductor-related parameters may include electrical measurement parameter values measured on one or more semiconductor devices.

The plurality of first neural network models may each have the same neural network structure and be trained through a training data set randomized through a plurality of epochs, so that weights within neural network models of the plurality of first neural network models have different values.

The machine-learning method may further include sorting a plurality of first output values output from the plurality of first neural network models in order of size, removing first output values that fall within a preset upper range and first output values that fall within a preset lower range among the plurality of first output values, and inputting, into a second neural network model, first output values remaining after the first output values that fall within the preset upper range and the first output values that fall within the preset lower range are removed.

The machine-learning method may further include outputting a plurality of second output values from the second neural network model based on the remaining first output values and calculating a final output value based on the plurality of second output values.

The second neural network model may be trained to transform the remaining first output values to have a same number as the plurality of second output values.

The final output value may be a mean value of the plurality of second output values or a median value among the plurality of second output values.

A semiconductor manufacturing process may be performed with at least one semiconductor manufacturing parameter as a target value. After the semiconductor manufacturing process is performed, the electrical measurement parameter values may be measured using one or more measuring devices. According to the semiconductor-related parameters, which are based on the at least one semiconductor manufacturing parameter and the electrical measurement parameter values measured using the one or more measuring devices, each of the plurality of first neural network models may determine the predicted figure of merit of the semiconductor device.

The machine-learning method may utilize a feedback loop between an output and an input of the plurality of first neural network models. The machine-learning method may further include computing an output value based on a plurality of first output values output from the plurality of first neural network models, updating the electrical measurement parameter values based on the output value, inputting updated semiconductor-related parameters into each of the plurality of first neural network models, and outputting, based on the updated semiconductor-related parameters, an updated predicted figure of merit of the semiconductor device as an updated first output value from each of the plurality of first neural network models. The updated semiconductor-related parameters may include the updated electrical measurement parameter values.

Updating the electrical measurement parameter values may include computing a gradient of the output value, and limiting at least one value of the updated electrical measurement parameter values to cause the at least one value to satisfy a preset limit. Updating the electrical measurement parameter values can enable the gradient to move in a preset direction.

The plurality of first neural network models may have different biases, and the plurality of first neural network models may have different local minima.

The plurality of first neural network models may be trained using a set of training data, including a fixed data set and a randomized data set. The randomized data may include a training data set and a verification data set.

In one or more aspects, there is provided a computing device including one or more processors, a memory, and one or more programs, in which the one or more programs are configured to be stored in the memory and executed by the one or more processors. The one or more programs may include instructions for inputting semiconductor-related parameters into each of a plurality of first neural network models and instructions for outputting, based on the semiconductor-related parameters, a predicted figure of merit of a semiconductor device as a first output value from each of the plurality of first neural network models. The semiconductor-related parameters may include electrical measurement parameter values measured on one or more semiconductor devices.

In one or more aspects, there is provided a machine-learning method for semiconductor process optimization that is executed in a computing device including one or more processors and a memory storing one or more programs executed by the one or more processors. The machine-learning method may include inputting semiconductor-related parameters into each of a plurality of neural network models, outputting, based on the semiconductor-related parameters, a predicted figure of merit of a semiconductor device as an output value from each of the plurality of neural network models, sorting a plurality of output values output from the plurality of neural network models in order of size, removing output values that fall within a preset upper range and output values that fall within a preset lower range among the plurality of output values, and calculating a final output value based on output values remaining after the output values that fall within the preset upper range and the output values that fall within the preset lower range are removed.

In one or more aspects, there is provided a computing device including one or more processors, a memory, and one or more programs, in which the one or more programs are configured to be stored in the memory and executed by the one or more processors. The one or more programs may include instructions for inputting semiconductor-related parameters into each of a plurality of neural network models, instructions for outputting, based on the semiconductor-related parameters, a predicted figure of merit of a semiconductor device as an output value from each of the plurality of neural network models, instructions for sorting a plurality of output values output from the plurality of neural network models in order of size, instructions for removing output values that fall within a preset upper range and output values that fall within a preset lower range among the plurality of output values, and instructions for calculating a final output value based on output values remaining after the output values that fall within the preset upper range and the output values that fall within the preset lower range are removed.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the appended drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings are incorporated in and constitute a part of this disclosure, illustrate aspects and embodiments of the disclosure, and together with the description serve to explain principles and examples of the disclosure.

FIG. 1 is a diagram schematically illustrating a machine-learning process of a semiconductor process optimization device using a neural network according to one or more example embodiments of the present disclosure.

FIG. 2 is a diagram schematically illustrating a process of optimizing electrical measurement parameters in the semiconductor process optimization device using a neural network according to one or more example embodiments of the present disclosure.

FIG. 3 is a diagram schematically illustrating a machine-learning process of a semiconductor process optimization device using a neural network according to one or more example embodiments of the present disclosure.

FIG. 4 is a diagram comparing a method using a single neural network and a method according to one or more example embodiments of the present disclosure.

FIG. 5 is an example of a block diagram illustrating a computing environment that includes a computing device according to one or more example embodiments of the present disclosure.

FIG. 6 is an example of a block diagram illustrating a system according to one or more example embodiments of the present disclosure.

Throughout the drawings and the detailed description, unless otherwise described, the same drawing reference numerals should be understood to refer to the same elements, features, and structures. The features, elements and depiction thereof may be exaggerated for clarity, illustration, and/or convenience.

### DETAILED DESCRIPTION

Hereinafter, specific example embodiments of the present disclosure are described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof may be omitted. The terms used below are defined in consideration of functions in the present disclosure, but may be changed depending on the customary practice, the intention of a user or operator, or the like. Thus, the definitions should be determined based on the overall content of the present specification. The terms used herein are only for describing example embodiments of the present disclosure, and should not be construed as limiting. Unless expressly stated otherwise, a singular form includes a plural form. Embodiments are example embodiments. Aspects are example aspects. In the present description, the terms “including,” “comprising,” “having,” and the like are used to indicate certain characteristics, numbers, steps, operations, elements, and a portion or combination thereof, but should not be interpreted to preclude one or more other characteristics, numbers, steps, operations, elements, and a portion or combination thereof.

In describing a temporal relationship, when the temporal order is described as, for example, “after,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

For the expression that an element is “connected,” “coupled,” “linked,” or the like to another element, the element can not only be directly connected, coupled, linked, or the like to another element, but also be indirectly connected, coupled, linked, or the like to another element with one or more intervening elements disposed or interposed between the elements, unless otherwise specified.

The term “at least one” should be understood as including any and all combinations of one or more of the associated listed items. For example, at least one of a plurality of elements can represent (i) one element of the plurality of elements, (ii) some elements of the plurality of elements, or (iii) all elements of the plurality of elements. The expression of a first element, a second elements “and/or” a third element should be understood as one of the first, second and third elements or as any or all combinations of the first, second and third elements. The term “or” means “inclusive or” rather than “exclusive or.” For example, “a or b” may mean “a,” “b,” or “a and b.”

Further, it will be understood that, although the terms first, second, and so on may be used herein to describe various elements, these elements should not be limited by these terms. These terms may be used to distinguish one element from another element. For example, without departing from the scope of the present disclosure, a first element could be termed a second element, and similarly, a second element could be termed a first element.

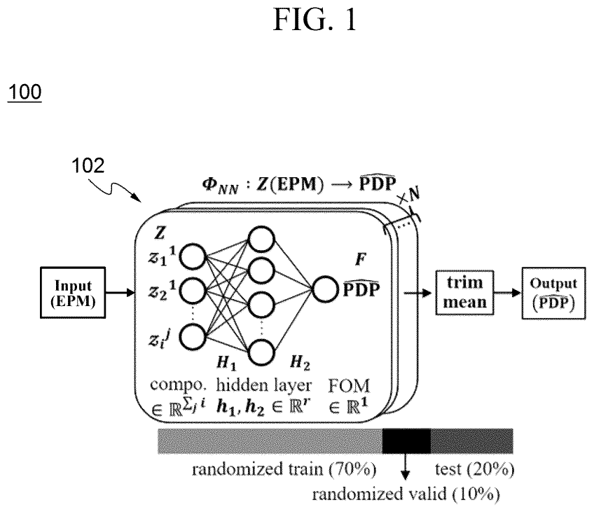

FIG. 1 is a diagram schematically illustrating a machine-learning process of a semiconductor process optimization device using a neural network according to one or more example embodiments of the present disclosure.

Referring to FIG. 1, a semiconductor process optimization device 100 may include a plurality of first neural network models 102. The plurality of first neural network models 102 may be arranged in parallel. Each of the plurality of first neural network models 102 may be a multi-layer perceptron (MLP). The plurality of first neural network models 102 may be N first neural network models arranged in parallel.

An electrical measurement parameter corresponding to each of semiconductor manufacturing parameters may be input into each of the plurality of first neural network models 102. Here, the semiconductor manufacturing parameters are design parameters used to manufacture a semiconductor of a specific structure. For example, when a semiconductor device includes transistors, the semiconductor manufacturing parameters may include gate length, oxide thickness, doping concentration, junction gradient, gate stack height, and so on.

In addition, the electrical measurement parameter is a measured parameter value that, after performing a semiconductor manufacturing process with the semiconductor manufacturing parameter as a target value, enables estimation of the semiconductor manufacturing parameter. For example, the electrical measurement parameter corresponding to the gate length may be an electrical critical dimension (ECD), and the electrical measurement parameter corresponding to the insulating film thickness may be an effective oxide thickness (EOT) and breakdown voltage (BV).

The plurality of first neural network models 102 may each predict a figure of merit (FOM) of the semiconductor device by using electrical measurement parameters as input. Hereinafter, electrical measurement parameters will be described as being used as input, but the present disclosure is not limited thereto and semiconductor manufacturing parameters may also be used as input. Electrical measurement parameters and semiconductor manufacturing parameters may be referred to as semiconductor-related parameters.

Here, figures of merit of the semiconductor device may include a power delay product (PDP), a frequency, a ring oscillator delay (ROD), power dissipation, a current-resistance (IR) drop, a voltage drop, and so on, but hereinafter, an example in which the figure of merit of the semiconductor device is power delay product (PDP) will be described. In an example, a PDP may be a metric used to evaluate the efficiency of a semiconductor device or circuit, and may represent the product of the power dissipation and the propagation delay of a semiconductor device or circuit.

When electrical measurement parameters are input, each of the plurality of first neural network models 102 may be trained to output the power delay product (PDP) of the corresponding semiconductor as a predicted value based on the input electrical measurement parameters. In this case, each first neural network model 102 may output one predicted value.

The plurality of first neural network models 102 may each have the same neural network structure. In an example embodiment, when the plurality of first neural network models 102 are trained, a test data set may be fixed at 20% of the total data set and the remaining 80% data set may be randomized with 70% being a training data set and 10% being a verification data set, which are divided a total of M times, and each of the plurality of first neural network models 102 may be trained through M epochs.

In this case, since the plurality of first neural network models 102 are trained through the training data set randomized during M epochs, the first neural network models 102 are trained so that weights within the neural network models have different values. That is, the plurality of first neural network models 102 may be trained to have different biases. Accordingly, the plurality of first neural network models 102 may have different local minima.

The semiconductor process optimization device 100 may sort output values (that is, predicted PDP values) of the plurality of first neural network models 102 in order of size. The semiconductor process optimization device 100 may remove output values that fall within a preset upper range (e.g., output values that exceed or are equal to a predetermined upper limit or a predetermined maximum level) and output values that fall within a preset lower range (e.g., output values that are less than or equal to a predetermined lower limit or a predetermined minimum level) from among a plurality of (that is, N) output values.

For example, the semiconductor process optimization device 100 may remove output values corresponding to a preset upper ratio and output values corresponding to a preset lower ratio among the plurality of output values. In addition, the semiconductor process optimization device 100 may remove output values that are equal to or greater than a preset upper threshold and output values that are less than or equal to a preset lower threshold in the Gaussian distribution of the plurality of output values.

The semiconductor process optimization device 100 may calculate a final output value (that is, a predicted final PDP value) based on output values remaining after the output values that fall within the preset upper range and the output values that fall within the preset lower range are removed among the plurality of output values.

In FIG. 1, the semiconductor process optimization device 100 has been illustrated as calculating a trimmed mean for the remaining output values and outputting it as the final output value, but the semiconductor process optimization device 100 is not limited thereto, and may output a median value of the remaining output values as the final output value. The semiconductor process optimization device 100 may train the plurality of first neural network models 102 to minimize the difference between the final output value and the correct answer value.

According to one or more example embodiments, by allowing the plurality of first neural network models 102 to have different biases and calculating the final output value based on the output values remaining after the output values that fall within the upper range and the output values that fall within the lower range are excluded among the output values of the plurality of first neural network models 102, it is possible to decrease a prediction error due to local minima of the plurality of first neural network models 102 and to derive optimal input with low output variance in a sparse data space.

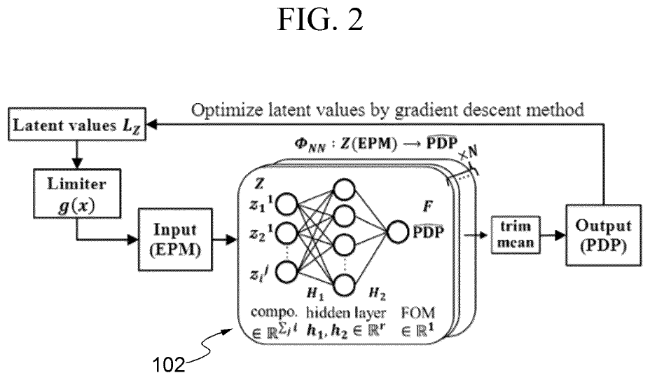

FIG. 2 is a diagram schematically illustrating a process of optimizing electrical measurement parameters in the semiconductor process optimization device using a neural network according to one or more example embodiments of the present disclosure. FIG. 2 illustrates a case of optimizing electrical measurement parameters using a gradient descent method.

Referring to FIG. 2, the semiconductor process optimization device 100 may input randomly selected initial electrical measurement parameters into the plurality of first neural network models 102. Then, the plurality of first neural network models 102 may each predict PDP values according to the input initial electrical measurement parameters. The semiconductor process optimization device 100 may remove PDP values that fall within a preset upper range and PDP values that fall within a preset lower range from among the predicted PDP values and output a final PDP value based on remaining PDP values.

The semiconductor process optimization device 100 may calculate a gradient of the final PDP value, and then update the electrical measurement parameters so that the calculated gradient moves in a negative direction using a preset machine-learning rate at time stamp t=0.

Meanwhile, the semiconductor process optimization device 100 may further include a limiter to prevent optimal electrical measurement parameters detected through the gradient descent method from exceeding a range (that is, the minimum to maximum value) of the electrical measurement parameters learned by the plurality of first neural network models 102. The limiter may receive a latent value with an unlimited random value (that is, −∞ to +∞) as input and use a limiter function to output the latent value within the previously learned range. The latent value may be a value generated by applying a sigmoid function to the electrical measurement parameters.

In one or more examples, the semiconductor process optimization device 100 may compute an output value (e.g., a final PDP value) based on a plurality of first output values output from the plurality of first neural network models 102 and then update the electrical measurement parameter values based on the output value. The semiconductor process optimization device 100 may then input the updated semiconductor-related parameters into each of the plurality of first neural network models 102 and output, based on the updated semiconductor-related parameters, an updated predicted figure of merit of the semiconductor device as an updated first output value from each of the plurality of first neural network models 102. The updated semiconductor-related parameters may include the updated electrical measurement parameter values. The semiconductor process optimization device 100 may thus utilize a feedback loop between an input and an output of the plurality of first neural network models 102, as shown in FIG. 2.

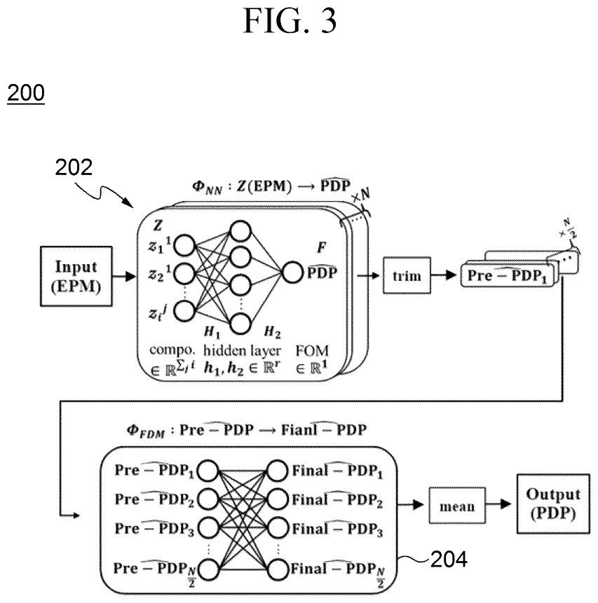

FIG. 3 is a diagram schematically illustrating a machine-learning process of a semiconductor process optimization device using a neural network according to one or more example embodiments of the present disclosure.

Referring to FIG. 3, a semiconductor process optimization device 200 may include a plurality of first neural network models 202 and a second neural network model 204. Since the plurality of first neural network models 202 are the same or similar to the plurality of first neural network models 102 illustrated in FIG. 1, detailed description thereof will be omitted.

The plurality of first neural network models 202 may be trained to predict the figure of merit (e.g., power delay product (PDP)) of a semiconductor device by each receiving electrical measurement parameters as input. N first neural network models 202 may be arranged in parallel. Each of the plurality of first neural network models 202 may output one first output value.

The semiconductor process optimization device 200 may sort first output values (that is, predicted PDP values) of the plurality of first neural network models 202 in order of size. The semiconductor process optimization device 200 may remove first output values that fall within a preset upper range and first output values that fall within a preset lower range (marked as “trim” in FIG. 3) from among a plurality of (that is, N) first output values.

The semiconductor process optimization device 200 may input remaining first output values Pre-PDP₁ to Pre-PDP_{N/2} (in FIG. 3, the number of the remaining first output values is shown as N/2, but is not limited thereto) into the second neural network model 204. The second neural network model 204 may be trained to output a plurality of second output values Final-PDP₁ to Final-PDP_{N/2} using the remaining first output values as input. In this case, the number (or the total number) of first output values and the number (or the total number) of second output values may be the same, but the present disclosure is not limited thereto.

The second neural network model 204 may serve to transform the remaining first output values into a plurality of second output values. That is, since the remaining first output values are the values remaining after the first output values that fall within the preset upper range and the first output values that fall within the lower range are removed, when the final output value is calculated using only the remaining first output values, values within the upper and lower ranges that have already been removed may not be derived. Accordingly, by transforming the remaining first output values into a plurality of second output values through the second neural network model 204, a biased value may be output according to the distribution of the remaining first output values.

The semiconductor process optimization device 200 may calculate a final output value based on the plurality of second output values of the second neural network model 204. In FIG. 3, the semiconductor process optimization device 200 has been illustrated as calculating a mean of the plurality of second output values and outputting it as the final output value, but the semiconductor process optimization device 200 is not limited thereto, and may set a median value of the plurality of second output values as the final output value.

The semiconductor process optimization device 200 may train the second neural network model 204 to minimize the difference between the final output value and the correct answer value. When the second neural network model 204 is trained, weights of the plurality of first neural network models 202 may be fixed. That is, the second neural network model 204 may be trained in a state in which the training of the plurality of first neural network models 202 has been completed.

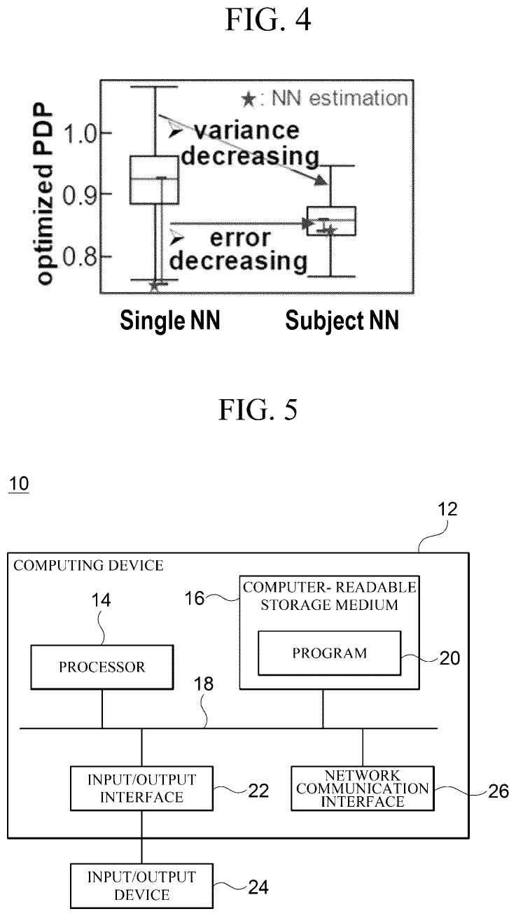

FIG. 4 is a diagram comparing a method using a single neural network (Single NN) and a method according to one or more example embodiments of the subject technology (Subject NN). Referring to FIG. 4, compared to the single neural network, when a method in accordance with one or more example embodiments of the subject technology is utilized, the prediction error decreases and the output variance decreases.

FIG. 5 is an example of a block diagram illustrating a computing environment 10 that includes a computing device according to one or more example embodiments of the present disclosure. In one or more example embodiments, each component may have a different function and capability in addition to those described below, and additional components may be included in addition to those described below.

The illustrated computing environment 10 includes a computing device 12. In one or more example embodiments, the computing device 12 may be the semiconductor process optimization device 100 or 200.

The computing device 12 includes at least one processor 14, a computer-readable storage medium 16, and a communication bus 18. The processor 14 may cause the computing device 12 to operate according to one or more example embodiments of the present disclosure. For example, the processor 14 may execute one or more programs stored in the computer-readable storage medium 16. The one or more programs may include one or more computer-executable instructions, which may be configured to cause, when executed by the processor 14, the computing device 12 to perform operations according to one or more example embodiments of the present disclosure.

The computer-readable storage medium 16 is configured to store computer-executable instructions or program codes, program data, and/or other suitable forms of information. A program 20 stored in the computer-readable storage medium 16 includes a set of instructions executable by the processor 14. In an example embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The example input/output device 24 may include a pointing device (e.g., a mouse, a trackpad, or the like), a keyboard, a touch input device (e.g., a touch pad, a touch screen, or the like), a voice or sound input device, input devices such as various types of sensor devices and/or imaging devices, and/or output devices such as a display device, a printer, an interlocutor, and/or a network card. The example input/output device 24 may be included inside the computing device 12 as one of components constituting the computing device 12, or may be connected to the computing device 12 as a separate device distinct from the computing device 12.

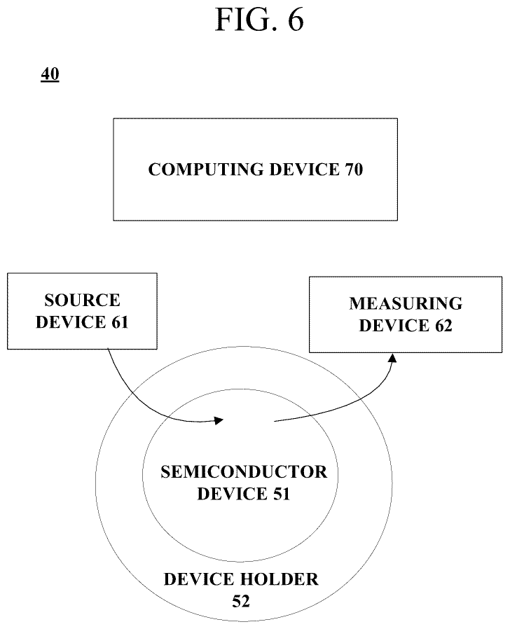

FIG. 6 is an example of a block diagram illustrating a system according to one or more example embodiments of the present disclosure. The system 40 may be an apparatus and may be a semiconductor process optimization system. The system 40 may include a semiconductor device 51, a device holder 52, a source device 61, a measuring device 62, and a computing device 70. The semiconductor device 51 (e.g., a wafer(s), a semiconductor die(s) or a circuit(s)) may be placed on the device holder 52 (e.g., a chuck) using vacuum or other methods. In some examples, a wafer may be 8 to 18 inches in diameter. In an example, a circuit may include thousands of transistors. In some examples, a wafer, a semiconductor die or a circuit may include millions or billions of transistors.

The source device 61 may include, for example, a signal generator(s), an electrical source(s), optical source(s), a current source(s), a voltage source(s), and/or a power source(s). The measuring device 62 may include, for example, an electrical meter(s), optical detector(s), a volt meter(s), a current meter(s), and/or power meter(s). The source device 61 may apply one or more signals (e.g., electrical signals, optical signals, current, voltage and/or power) to the semiconductor device 51 using, for example, a probe(s), a probe card, or the like. The measuring device 62 may measure or detect one or more signals (e.g., electrical signals, optical signals, voltage, current, and/or power) output from the semiconductor device 51. The measuring device 62 may supply the measured or detected signals to the computing device 70. The computing device 70 may control, communicate with, or be coupled to the source device 61 and/or the measuring device 62 using wired communication interfaces or wireless communication interfaces. The computer device 70 may be local or remote to the source device 61 and/or the measuring device 62. In one or more examples, the computing device 70 may be the computing environment 10 or the computing device 12.

In one or more examples, a semiconductor device 51 may be one or more semiconductor devices. A source device 61 may be one or more source devices. A measuring device 62 may be one or more measuring devices.

According to one or more example embodiments of the present disclosure, by allowing a plurality of neural network models to have different biases and calculating a final output value based on remaining output values after output values that fall within an upper range and output values that fall within a lower range are excluded among output values of the plurality of neural network models, it is possible to decrease a prediction error due to local minima of the plurality of neural network models and to derive optimal input with low output variance in a sparse data space.

Although the representative embodiments of the present disclosure have been described in detail as above, those skilled in the art will understand that various modifications may be made thereto without departing from the scope of the present disclosure. Therefore, the scope of the present disclosure should not be limited to the described embodiments. The scope of protection of the present disclosure should be construed based on the following claims, and all technical features within the scope of equivalents thereof should be construed as being included within the scope of the present disclosure.

What is claimed is:

1. A machine-learning method for semiconductor process optimization that is executed in a computing device including one or more processors and a memory storing one or more programs executed by the one or more processors, the machine-learning method comprising:
inputting semiconductor-related parameters into each of a plurality of first neural network models; and
outputting, based on the semiconductor-related parameters, a predicted figure of merit of a semiconductor device as a first output value from each of the plurality of first neural network models,
wherein the semiconductor-related parameters comprise electrical measurement parameter values measured on one or more semiconductor devices.

2. The machine-learning method of claim 1, wherein each of the plurality of first neural network models includes a same neural network structure and is trained through a training data set randomized through a plurality of epochs, so that weights within neural network models of the plurality of first neural network models have different values.

3. The machine-learning method of claim 2, further comprising:
sorting a plurality of first output values output from the plurality of first neural network models in order of size;
removing first output values that fall within a preset upper range and first output values that fall within a preset lower range among the plurality of first output values; and
inputting, into a second neural network model, first output values remaining after the first output values that fall within the preset upper range and the first output values that fall within the preset lower range are removed.

4. The machine-learning method of claim 3, further comprising:
outputting a plurality of second output values from the second neural network model based on the remaining first output values; and
calculating a final output value based on the plurality of second output values.

5. The machine-learning method of claim 4, wherein the second neural network model is trained to transform the remaining first output values to have a same number of values as the plurality of second output values.

6. The machine-learning method of claim 4, wherein the final output value is a mean value of the plurality of second output values or a median value among the plurality of second output values.

7. The machine-learning method of claim 1, wherein:
a semiconductor manufacturing process is performed with at least one semiconductor manufacturing parameter as a target value;
after the semiconductor manufacturing process is performed, the electrical measurement parameter values are measured using one or more measuring devices; and
according to the semiconductor-related parameters, which are based on the at least one semiconductor manufacturing parameter and the electrical measurement parameter values measured using the one or more measuring devices, each of the plurality of first neural network models determines the predicted figure of merit of the semiconductor device.

8. The machine-learning method of claim 1,
wherein the machine-learning method utilizes a feedback loop between an output and an input of the plurality of first neural network models,
wherein the machine-learning method further comprises:
computing an output value based on a plurality of first output values output from the plurality of first neural network models;
updating the electrical measurement parameter values based on the output value;
inputting updated semiconductor-related parameters into each of the plurality of first neural network models; and
outputting, based on the updated semiconductor-related parameters, an updated predicted figure of merit of the semiconductor device as an updated first output value from each of the plurality of first neural network models, and
wherein the updated semiconductor-related parameters comprise the updated electrical measurement parameter values.

9. The machine-learning method of claim 8,
wherein updating the electrical measurement parameter values comprises:
computing a gradient of the output value; and
limiting at least one value of the updated electrical measurement parameter values to cause the at least one value to satisfy a preset limit, and
wherein updating the electrical measurement parameter values enables the gradient to move in a preset direction.

10. The machine-learning method of claim 1, wherein:
the plurality of first neural network models have different biases; and
the plurality of first neural network models have different local minima.

11. The machine-learning method of claim 1, wherein:
the plurality of first neural network models are trained using a set of training data;
the set of training data comprises a fixed data set and a randomized data set; and
the randomized data comprises a training data set and a verification data set.

12. A computing device, comprising:
one or more processors;
a memory; and
one or more programs,
wherein the one or more programs are configured to be stored in the memory and executed by the one or more processors, and
the one or more programs include:
instructions for inputting semiconductor-related parameters into each of a plurality of first neural network models; and
instructions for outputting, based on the semiconductor-related parameters, a predicted figure of merit of a semiconductor device as a first output value from each of the plurality of first neural network models,
wherein the semiconductor-related parameters comprise electrical measurement parameter values measured on one or more semiconductor devices.

13. The computing device of claim 12, wherein each of the plurality of first neural network models includes a same neural network structure and is trained through a training data set randomized through a plurality of epochs, so that weights within neural network models of the plurality of first neural network models have different values.

14. The computing device of claim 13, wherein the one or more programs further include:
instructions for sorting a plurality of first output values output from the plurality of first neural network models in order of size;
instructions for removing first output values that fall within a preset upper range and first output values that fall within a preset lower range among the plurality of first output values; and
instructions for inputting, into a second neural network model, first output values remaining after the first output values that fall within the preset upper range and the first output values that fall within the preset lower range are removed.

15. The computing device of claim 14, wherein the one or more programs further include:
instructions for outputting a plurality of second output values from the second neural network model based on the remaining first output values; and
instructions for calculating a final output value based on the plurality of second output values.

16. The computing device of claim 15, wherein the second neural network model is trained to transform the remaining first output values to have a same number of values as the plurality of second output values.

17. The computing device of claim 15, wherein the final output value is a mean value of the plurality of second output values or a median value among the plurality of second output values.

18. A machine-learning method for semiconductor process optimization that is executed in a computing device including one or more processors and a memory storing one or more programs executed by the one or more processors, the machine-learning method comprising:
inputting semiconductor-related parameters into each of a plurality of neural network models;
outputting, based on the semiconductor-related parameters, a predicted figure of merit of a semiconductor device as an output value from each of the plurality of neural network models;
sorting a plurality of output values output from the plurality of neural network models in order of size;
removing output values that fall within a preset upper range and output values that fall within a preset lower range among the plurality of output values; and
calculating a final output value based on output values remaining after the output values that fall within the preset upper range and the output values that fall within the preset lower range are removed.

19. The machine-learning method of claim 18, wherein each of the plurality of neural network models includes a same neural network structure and is trained through a training data set randomized through a plurality of epochs, so that weights within neural network models of the plurality of neural network models have different values.

20. The machine-learning method of claim 18, wherein the final output value is a mean value of the remaining output values or a median value among the remaining output values.
